(19) United States
(12) Patent Application Publication
(10) Pub. No.: US 2016/0108229 A1
(43) Pub. Date: Apr. 21, 2016

(54) COMPOSITION OF POLY-ARYLENE ETHER KETONE KETONE POWDERS SUITABLE FOR LASER SINTERING

(71) Applicant: ARKEMA FRANCE, Colombes (FR)

(72) Inventors: Nadine DECRAEMER, Beaumontel (FR); Denis HUZE, Fontaine Sous Jouy (FR); Cyrille MATHIEU, Rouen (FR); Herve STER, Serquigny (FR); Jerome PASCAL, Grandchain (FR); Benoit BRULE, Beaumont-Le-Roger (FR)

(73) Assignee: ARKEMA FRANCE, Colombes (FR)

(21) Appl. No.: 14/894,810

(22) PCT Filed: May 27, 2014
(86) PCT No.: PCT/FR2014/051239

§ 371 Date: Nov. 30, 2015

(30) Foreign Application Priority Data
May 30, 2013 (FR) 13 54916

(51) Int. Cl. C08L 61/16

(52) U.S. Cl. CPC C08L 61/16

(57) ABSTRACT

The present invention relates to a composition comprising at least one poly(arylene ether ketone) powder suitable for laser sintering and also to the process which makes it possible to obtain it, minimizing the amount by weight of remaining non-sintered powder after production of the part by sintering.

The present invention relates to a composition comprising at least one poly(arylene ether ketone) powder suitable for laser sintering and also to the process which makes it possible to obtain it, minimizing the amount by weight of remaining non-sintered powder after production of the part by sintering.

Poly(arylene ether ketone)s and more particularly poly(ether ketone ketone)s (PEKK) are high performance materials. They are used for applications which are restricting in temperature and/or in mechanical stresses, indeed even chemical stresses. These polymers are encountered in fields as varied as aeronautics, offshore drilling or medical implants. They can be employed by molding, extrusion, compression, spinning or also laser sintering in particular. However, their use in this final process requires conditions of preparation of the powder providing a good flowability which makes possible use in the laser sintering process as described below.

The technology for the sintering of powders under a laser beam is used to manufacture three-dimensional objects, such as prototypes or models but also functional parts, in particular in the motor vehicle, nautical, aeronautical, aerospace, medical (prostheses, auditory systems, cell tissues, and the like), textile, clothing, fashion, decorative, electronic casing, telephony, home automation, computing or lighting fields.

A fine layer of powder is deposited on a horizontal plate maintained in a chamber heated to a certain temperature. The laser contributes the energy necessary to sinter the powder particles at different points of the powder layer according to a geometry corresponding to the object, for example using a computer having, in memory, the shape of the object and reproducing the shape in the form of slices. Subsequently, the horizontal plate is lowered by a value corresponding to the thickness of a powder layer (for example between 0.05 and 2 mm and generally of the order of 0.1 mm), then a new powder layer is deposited and the laser contributes the energy necessary to sinter the powder particles according to a geometry corresponding to this new slice of the object, and so on. The procedure is repeated until the entire object has been manufactured. An object surrounded by non-sintered powder is obtained inside the chamber. The parts which have not been sintered have thus remained in the powder state. After complete cooling, the object is separated from the powder, which can be reused for another operation. In this process, the non-sintered powder can represent up to 90% by weight, which results in a large amount by weight of powder to be recycled, bringing about major handling operations, risks of contamination, indeed even detrimental changes in the quality of the recycled part (yellowing, chemical decomposition).

Conditions are thus desired which make it possible to limit the amount by weight of non-sintered powder to be recycled by maximizing the ratio of sintered powder to non-sintered powder.

One way of limiting this amount of powder consists in using a powder exhibiting the lowest possible density. The density is defined as the ratio of the weights by volume of the material under consideration to that of water and thus does not exhibit a unit. However, for the sake of consistency with what is often read in the literature, the density can be put in the same category as the weight by volume and can be expressed in kg/m³.

Unfortunately, the knowledge of a person skilled in the art generally results in the use of powders, the density of which is increased by a treatment necessary to improve the flowability thereof, typically greater than 400 kg/m³. To date, it has not been possible to combine a good flowability and a low density.

U.S. Pat. No. 7,847,057 relates to a process for the heat treatment of poly(arylene ether ketone) powders, which consists in exposing the powder to a heat treatment of greater than 30 minutes at a temperature greater than 20° C. to the glass transition temperature of the polymer. This treatment, applied to poly(ether ether ketone)s, makes it possible to obtain powders with a flowability acceptable for the laser sintering process but results in an increase in the density which can range up to 20%. This heat treatment makes it possible to render the surface of the PEEK powder less rough, which explains their better flowability.

WO2012047613 also describes a heat treatment applied more particularly to poly(ether ketone ketone) (PEKK) powders which consists in exposing the powder to a heat treatment of several hours between the transition temperatures of the different crystalline phases, more particularly while approaching the melting point of the polymer corresponding to the crystalline form exhibiting the transition at the highest temperature. The flowability of the powder is found to be improved thereby and the crystallinity resulting from this treatment is retained during the sintering process, conferring certain advantageous physical properties on the sintered object.

In order to respond to the requirements to have available powders of low density and exhibiting a good flowability, the applicant company has carried out a series of tests demonstrating that, for certain PEKKs, an appropriate heat treatment allows powders to be obtained which exhibit both the criterion of low density and of good flowability. It should be noted that the powder, thus heat treated, surprisingly has a rougher surface than the initial powder, as may be observed by scanning electron microscopy. This results in a smaller amount of powders to be recycled in a laser sintering process but also makes possible an increase in the rate of layer formation while producing defect-free parts.

### SUMMARY OF THE INVENTION

The invention relates to a composition comprising a PEKK powder, the tapped density of which, measured according to ISO 1068-1975 (F), is less than 400 kg/m³, limit included, preferably less than 370 kg/m³ and more preferably still less than 340 kg/m³, and the flowability of which exhibits a passage time in a 12 mm funnel of less than 50 s, limit included, preferably of less than 40 s, or a passage time in a 17 mm funnel of less than 30 s, preferably of less than 25 s, said flowability being measured in the following way:
Glass funnels with an orifice of 17 or 12 mm are filled with the powder up to 5 mm from the edge. The orifice of the bottom is blocked with the finger.
The flow time of the powder is measured with a stopwatch.
If flow does not take place, the funnel is tapped using a spatula. The operation is repeated, if required.
The flow time and the number of tapped blows using the spatula are recorded.

The invention also relates to the heat treatment process which makes it possible to obtain such powders and to the objects obtained by the process using such powders, in particular the objects obtained by a laser sintering technology.

### DETAILED DESCRIPTION

The poly(arylene ether ketone)s used in the invention comprise units of formula IA, of formula IB and their mixture.

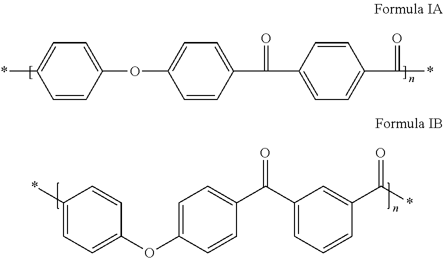

In a more general context, the poly(arylene ether ketone)s corresponding to the generic names PEK, PEEKEK, PEEK or PEKEKK (where E denotes an ether functional group and K a ketone functional group) cannot be excluded, in particular when their use takes place in a way combined with that of PEKK in proportions by weight where the PEKK represents more than 50% as proportion by weight and preferably more than 80% as proportion by weight, limits included. Preferably, the poly(arylene ether ketone)s are poly(ether ketone ketone)s comprising a mixture of IA and IB units, so that the percentage by weight of terephthalic units with respect to the sum of the terephthalic and isophthalic units is between 55% and 85% and preferably between 55% and 70%, ideally 60%. Terephthalic and isophthalic unit is understood to mean the formula of terephthalic acid and isophthalic acid respectively.

These poly(arylene ether ketone)s are provided in the form of powders which may have been prepared by milling or precipitation.

They exist, after the heat treatment process of the invention, in the form of a powder, the tapped density of which is less than 400 kg/m³, limit included, preferably less than 370 kg/m³ and more preferably less than 340 kg/m³, this density being measured according to the standard ISO 1068-1975 (F) , a flowability in a 12 mm funnel of less than 50 s and preferably of less than 40 s or a flowability in a 17 mm funnel of less than 30 s and preferably of less than 25 s.

The powders or mixtures of powders used in the process can be obtained, for example, by a milling process described in the application FR 1160258. They can, if appropriate, be additivated with or contain different compounds, such as reinforcing fillers, in particular inorganic fillers, such as carbon black, nanotubes, which may or may not be of carbon, fibres, which may or may not be ground, stabilizing agents (light, in particular UV, and heat stabilizing agents), glidants, such as silica, or also optical brighteners, dyes, pigments or a combination of these fillers or additives.

The process for the treatment of such powders in accordance with the invention and which makes it possible to obtain the powders in accordance with the invention consists in causing the powder to reside in a static or dynamic device, typically a ventilated chamber held at temperature, typically between a temperature T−10° C. and T+10° C., where T=3.75*A+37.5, expressed in ° C. (A, representing the percentage by weight of terephthalic unit with respect to the sum of the terephthalic and isophthalic units, is between 55% and 85%), preferably between T−5° C. and T+5° C. and more preferably between T−3° C. and T+3° C., ideally T, for times which can vary according to the type of heating chamber used, typically greater than 2 minutes. Mention may be made, among the types of heating chambers under consideration, without limitation, of ventilated ovens, fluidized beds, flash dryers, vane dryers, vertical shaft dryers, rotary ovens or also tunnels heated using infrared lamps. It would not be departing from the scope of the invention to carry out several successive heat treatments (at the same temperature or at two different temperatures of between T−10° C. and T+10° C., where T=3.75*A+37.5, expressed in ° C., A representing the percentage by weight of terephthalic unit with respect to the sum of the terephthalic and isophthalic units). In the latter case, the temperature of the 2^{nd} treatment is greater than the temperature of the 1^{st} treatment.
The powder resulting from this heat treatment is subsequently used in a device for sintering powders under a laser beam in order to make possible the manufacture of an object.
Whereas, in this process for the manufacture of an object, it is not rare to find that only 10% by weight of the powder is actually sintered, the remainder having to be recycled, the use of the powders which are a subject matter of the invention and which are treated by the process of the invention makes it possible to obtain, starting from “low” density (that is to say, <400 kg/m³) powder, a sintered part with a typical density of 1290 kg/m³ plus or minus 20 kg/m³ with a residual porosity of the sintered part of less than or equal to 2%. The proportion by weight of non-sintered powder remaining to be reused is thus lower with the powder of the invention (density <400 kg/m³) than with the powders obtained according to the prior art, this resulting in a spectacular increase in productivity by minimizing major handling operations, contamination, indeed even detrimental changes in the quality of the recycled part, in order to obtain objects exhibiting fewer defects.

### EXAMPLES

### Example 1

### Measurement of the Density

The tapped and bulk densities are measured according to the standard ISO 1068-1975 (F) in the following way:

### Tapped and Bulk Densities

The balance is tared with the empty measuring cylinder cleaned and dried beforehand.
A volume of powder is introduced into an accurate graduated 250 ml glass measuring cylinder.
If necessary, the free surface of the powder is levelled, without tapping it, and the volume V₀ is recorded.
The measuring cylinder with the powder is weighed with a balance accurate to 0.1 g.
The measuring cylinder is placed on the plate of the STAV 2003 tapping device.
Tapping is carried out with 1250 drops and V₁ is recorded.
Tapping is carried out with 1250 drops and V₂ is recorded.
The tapping operation is repeated until two equivalent volumes Vi are obtained. V_{f} is recorded.
   The bulk density is the weight of powder introduced divided by V₀.
   The tapped density is the weight of powder introduced divided by V_{f}.
   It is expressed in kg/m³.

### Example 2

### Measurement of the Flowability

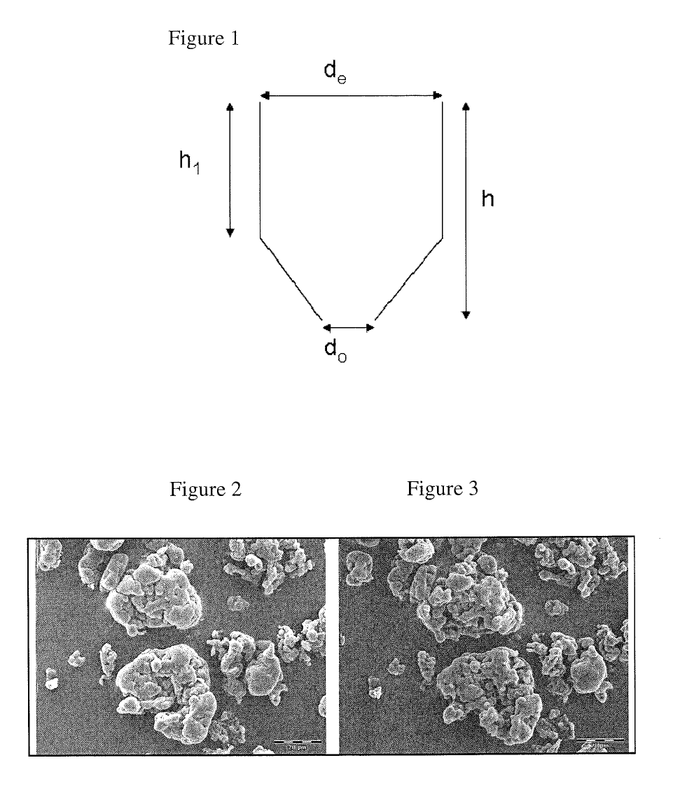

The flowability of these powders was carried out in glass funnels in the following way:
Glass funnels with an orifice of 17 or 12 mm (FIG. 1) are filled with the powder up to 5 mm from the edge. The orifice of the bottom is blocked with the finger.
   With for the 12 mm funnel:
   dₑ=39.2 mm
   dₒ=12 mm
   h=106 mm
   h₁=83 mm
   and for the 17 mm funnel:
   dₑ=42.0 mm
   dₒ=17 mm
   h=112 mm
   h₁=67 mm
The flow time of the powder is measured with a stopwatch.
If flow does not take place, the funnel is tapped using a spatula. The operation is repeated, if required.
The flow time and the number of tapped blows using the spatula are recorded.

### Example 3

A Kepstan® 6003 powder from Arkema, containing 60% of terephthalic units with respect to the sum of the terephthalic and isophthalic units, the particle size of which exhibits a dv50 of 50 μm plus or minus 5 μm, with a bulk density of 235 kg/m³ and with a tapped density of 355 kg/m³, is subjected to different heat treatments in a crystallizing dish in a ventilated oven. The powder is arranged in a crystallizing dish so that the thickness of the powder bed is between 1 and 1.5 cm.

The Dv50 is also referred to here as median diameter by volume, which corresponds to the value of the particle size which divides the population of particles examined exactly into two. The Dv50 is measured according to the standard ISO 9276—parts 1 to 6. In the present description, a Malvern particle sizer, Mastersizer 2000, is used and the measurement is carried out by the liquid route by laser diffraction on the powder.
After treatment, the powders were sieved on a 250 μm vibrating sieve in order to deagglomerate them.
The results are given in table 1 for residence times of 16 h.

TABLE 1

| | | | 16 h at | 16 h at | 19 h at |
|---|---|---|---|---|---|
| | | T = 0 | 200° C. | 260° C. | 285° C. |
| Bulk density (Kg/m³) | | 235 | 238 | 235 | 205 |
| Tapped density (Kg/m³) | | 355 | 350 | 335 | 315 |
| Flowability, | Time (s) | 95 | 55 | 30 | 50 |
| 12 mm | Number of | multi | multi | 25 | multi |
| funnel | blows | | | | |
| Flowability, | Time (s) | 50 | 40 | 10 | 40 |
| 17 mm | Number of | 40 | 30 | 4 | 27 |
| funnel | blows | | | | |

| | | | | |
|---|---|---|---|---|
| Moisture content | 0.45% | 0.16% | 0.23% | 0.23% |

The results clearly show that a treatment at 260° C. very significantly improves the flowability while reducing the tapped density.
The effect of the heat treatment on the morphology of the powders can be viewed with a scanning electron microscope in FIG. 2 (before heat treatment) and in FIG. 3 (after heat treatment). It is apparent, on these same powder particles observed before and after the heat treatment, that the temperature treatment according to the invention results in a roughness of the powder particles.

1. A composition comprising a PEKK powder, the tapped density of which is less than 400 kg/m³, limit included, measured according to ISO 1068-1975 (F), and the flowability of which exhibits a passage time in a 12 mm funnel of less than 50 s, limit included, or a passage time in a 17 mm funnel of less than 30 s.

2. The composition as claimed in claim 1, wherein the PEKK exhibits a percentage by weight of terephthalic unit with respect to the sum of the terephthalic and isophthalic units of between 55% and 85%.

3. The composition as claimed in claim 1, comprising, in addition to the PEKK powder, a PEK, PEEKEK, PEEK or PEKEKK powder, the PEKK powder representing more than 50% by weight, limit included.

4. The composition as claimed in claim 1, additionally comprising a filler.

5. The composition as claimed in claim 1, additionally comprising at least one additive.

6. A heat treatment process for preparing a PEKK powder the tapped density of which is less than 400 kg/m³ limit included, measured according to ISO 1068-1975 (F), and the flowability of which exhibits a passage time in a 12 mm funnel of less than 50 s, limit included, or a passage time in a 17 mm funnel of less than 30 s, the process comprising the following stages:
arranging a PEKK powder in a ventilated chamber in a static or dynamic device;
heating the PEKK powder at a temperature between T−10° C. and T+10° C., where T=3.75*A+37.5, expressed in ° C., A representing the percentage by weight of terephthalic unit with respect to the sum of the terephthalic and isophthalic units and is between 55% and 85%, for a time of greater than 2 minutes.

7. A method, comprising sintering a composition as claimed in claim 1 in a laser sintering device.

8. A method, comprising sintering a composition as claimed in claim 1 under a laser beam, whereby the amount of PEKK powder to be recycled is minimized.
